(19) United States
(12) Patent Application Publication
(10) Pub. No.: US 2023/0198697 A1
(43) Pub. Date: Jun. 22, 2023

(54) COMMUNICATION DEVICE, SYSTEM, COMMUNICATION METHOD, AND NON-TRANSITORY COMPUTER-READABLE STORAGE MEDIUM

(71) Applicant: KABUSHIKI KAISHA TOKAI RIKA DENKI SEISAKUSHO, Aichi (JP)

(72) Inventors: Masateru FURUTA, Aichi (JP); Tadashi FUKAGAI, Aichi (JP); Yuki KONO, Aichi (JP); Yutaka KUBO, Aichi (JP)

(73) Assignee: KABUSHIKI KAISHA TOKAI RIKA DENKI SEISAKUSHO, Aichi (JP)

(21) Appl. No.: 18/061,174

(22) Filed: Dec. 2, 2022

(30) Foreign Application Priority Data
Dec. 20, 2021 (JP) 2021-205773

(51) Int. Cl. H04L 5/00; H04W 64/00

(52) U.S. Cl. CPC H04L 5/0046; H04W 64/003

(57) ABSTRACT

There is provided a communication device comprising: a control unit configured to control ranging with a wireless signal in conformity with a regulated communication standard, wherein the control unit controls output intensity of a data transmission signal that has a payload based on reception sensitivity for a plurality of ranging signals transmitted to and received from other communication devices.

### CROSS REFERENCE TO RELATED APPLICATION(S)

This application is based upon and claims benefit of priority from Japanese Patent Application No. 2021-205773, filed on Dec. 20, 2021, the entire contents of which are incorporated herein by reference.

### BACKGROUND

The present invention relates to a communication device, a system, a communication method, and a non-transitory computer-readable storage medium.

In recent years, technologies for performing processes based on wireless signals transmitted and received between devices have been developed. For example, JP 2020-118030 A discloses a technology for performing ranging between devices by using an ultra-wideband signal.

### SUMMARY

In ranging, a ranging signal used for recording a time to calculate a ranging value and a data transmission signal that has, for example, a payload including information or the like regarding the time are transmitted and received.

However, the reception sensitivity for a data transmission signal is normally lower than reception sensitivity for a ranging signal. Therefore, when the data transmission signal cannot be received normally despite normal completion of transmission and reception of the ranging signal, a situation where the ranging value cannot be calculated can occur.

Accordingly, the present invention has been devised in view of the foregoing problem and an objective of the present invention is to calculate a ranging value more reliably.

To solve the above described problem, according to an aspect of the present invention, there is provided a communication device comprising: a control unit configured to control ranging with a wireless signal in conformity with a regulated communication standard, wherein the control unit controls output intensity of a data transmission signal that has a payload based on reception sensitivity for a plurality of ranging signals transmitted to and received from other communication devices.

To solve the above described problem, according to another aspect of the present invention, there is provided a system comprising: the communication device; and another communication device configured to receive a data transmission signal from the communication device.

To solve the above described problem, according to another aspect of the present invention, there is provided a communication method comprising: controlling ranging with a wireless signal in conformity with a regulated communication standard, wherein the controlling includes controlling output intensity of a data transmission signal that has a payload based on reception sensitivity for a plurality of ranging signals transmitted to and received from other communication devices.

To solve the above described problem, according to another aspect of the present invention, there is provided a non-transitory computer-readable storage medium that stores a program causing a computer to realize a control function of controlling ranging with a wireless signal in conformity with a regulated communication standard, wherein the control function is caused to control output intensity of a data transmission signal that has a payload based on reception sensitivity for a plurality of ranging signals transmitted to and received from other communication devices.

According to the above-described present invention, it is possible to calculate a ranging value more reliably.

### BRIEF DESCRIPTION OF THE DRAWINGS

FIG. 1 is a block diagram illustrating an exemplary configuration of a communication device according to an embodiment of the present invention.

FIG. 2 is a sequence diagram illustrating an example of a ranging flow between a portable device and an in-vehicle device according to the embodiment.

FIG. 3 is a diagram illustrating an example of a data structure of a ranging signal according to the embodiment.

FIG. 4 is a diagram illustrating an example of a data structure of a data transmission signal according to the embodiment.

### DETAILED DESCRIPTION OF THE EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### EMBODIMENT

### System Configuration Example

First, an exemplary configuration of a system 1 according to an embodiment of the present invention will be described.

The system 1 according to the embodiment includes a plurality of communication devices 10 that transmits and receives a wireless signal in conformity with a regulated communication standard.

### (Communication Device 10)

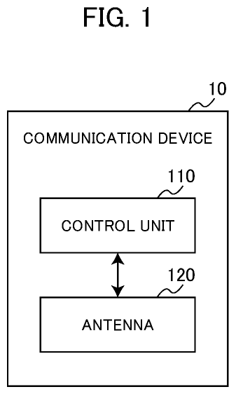

FIG. 1 is a block diagram illustrating an exemplary configuration of the communication device 10 according to the embodiment. As illustrated in FIG. 1, the communication device 10 according to the embodiment includes a control unit 110 and an antenna 120.

### (Control Unit 110)

The control unit 110 according to the embodiment controls ranging in which a wireless signal in conformity with a regulated communication standard is used.

For example, the control unit 110 according to the embodiment controls transmission and reception of the wireless signal to and from another communication device 10.

For example, an ultra-wideband wireless communication can be exemplified as the regulated communication standard according to the embodiment.

Here, the regulated communication standard according to the embodiment is not limited to the foregoing example.

In the regulated communication standard according to the embodiment, any scheme which can be used for ranging and is capable of transmitting and receiving a signal with a predetermined format including a preamble and a payload to be described below can be adopted.

A function of the control unit 110 according to the embodiment is realized by any of various processors. The function of the control unit 110 according to the embodiment will be described separately in detail.

### Antenna 120

The antenna 120 according to the embodiment transmits and receives a wireless signal in conformity with a regulated communication standard with another communication device 10.

For example, the antenna 120 according to the embodiment transmits a ranging signal used for recording a time to calculate a ranging value and a data transmission signal that has a payload including various kinds of information under the control of the control unit 110.

On the other hand, the antenna 120 according to the embodiment may receive a ranging signal and a data transmission signal from another communication device 10.

The exemplary configuration of the communication device 10 according to the embodiment has been described. The configuration described with reference to FIG. 1 is merely exemplary and a configuration of the communication device 10 according to the embodiment is not limited to this example.

For example, the communication device 10 according to the embodiment may further include a manipulation input unit that receives a manipulation from a user and a communication unit that transmits and receives a wireless signal in conformity with another communication standard different from the regulated communication standard.

The configuration of the communication device 10 and the system 1 according to the embodiment can be modified flexibly in accordance with specifications or operations.

### Details of Control

Next, control according to the embodiment will be described in detail.

Hereinafter, a case in which the system 1 according to the embodiment includes a portable device 20 and an in-vehicle device 30 will be described.

Each of the portable device 20 and the in-vehicle device 30 is an example of the communication device 10 according to the embodiment.

More specifically, the in-vehicle device 30 may be the communication device 10 mounted on a moving object such as a vehicle. The portable device 20 may be the communication device 10 that is carried by a user of the moving object.

For example, the in-vehicle device 30 may perform control such as opening of a door of a moving object when a ranging value calculated based on transmission and reception of a wireless signal to and from the portable device 20 is equal to or less than a regulated value, that is, the user carrying the portable device 20 is estimated to be within a regulated distance from the moving object.

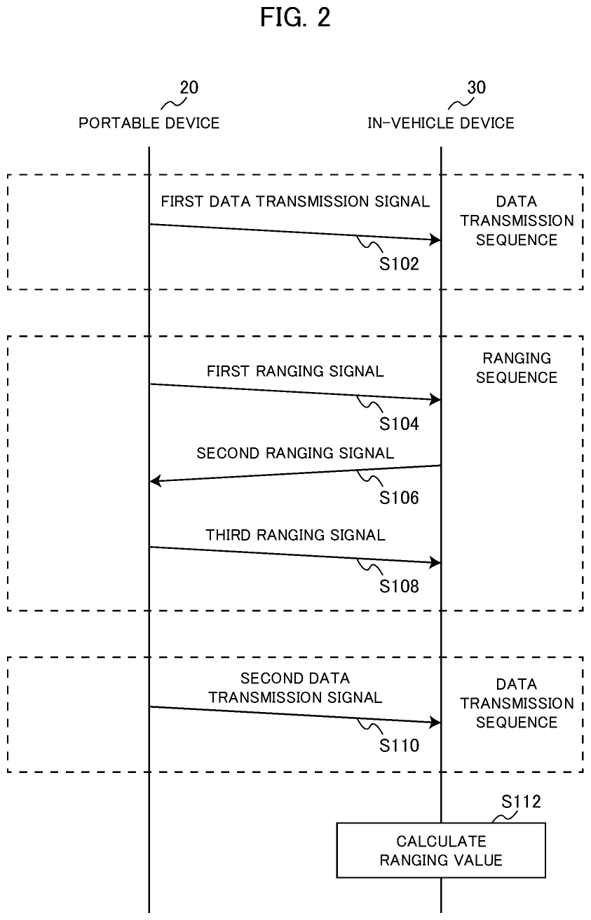

FIG. 2 is a sequence diagram illustrating an example of a ranging flow between the portable device 20 and the in-vehicle device 30 according to the embodiment.

As illustrated in FIG. 2, the transmission and reception of a wireless signal between the portable device 20 and the in-vehicle device 30 are roughly classified into a ranging sequence in which a ranging signal used for recording a time to calculate a ranging value is transmitted and received and a data transmission sequence in which a data transmission signal that has a payload including various kinds of information is transmitted and received.

In the case of the example illustrated in FIG. 2, a first data transmission signal transmitted from the portable device 20 is first received by the in-vehicle device 30 in the data transmission sequence (S102).

A payload included in the first data transmission signal transmitted and received in step S102 may include various kinds of information necessary for a series of subsequent processes.

Subsequently, in the ranging sequence, a first ranging signal transmitted from the portable device 20 is received by the in-vehicle device 30 (S104).

In step S104, the in-vehicle device 30 receiving the first ranging signal transmits a second ranging signal as a response to the first ranging signal (S106).

In step S106, the portable device 20 receiving the second ranging signal transmits a third ranging signal (S108).

Subsequently, in the data transmission sequence, the portable device 20 transmits a second data transmission signal to the in-vehicle device 30 (S110).

Subsequently, the in-vehicle device 30 calculates a ranging value based on transmission and reception times of the first to third ranging signals transmitted and received in the ranging sequence (S112).

Here, the portable device 20 sets a time length from the transmission of the first ranging signal to the reception of the second ranging signal as a time length T1 and sets a time length from the reception of the second ranging signal to the transmission of the third ranging signal as a time length T2.

The in-vehicle device 30 sets a time length from the reception of the first ranging signal to the transmission of the second ranging signal as a time length T3 and sets a time length from the transmission of the second ranging signal to the reception of the third ranging signal as a time length T4.

In this case, the in-vehicle device 30 can calculate a propagation time τ of the ranging signal using the following Expression (1).

τ=(T1×T4−T2×T3)/(T1+T2+T3+T4) (1)

At this time, the in-vehicle device 30 can acquire the time lengths T3 and T4 from its own transmission and reception records.

On the other hand, the in-vehicle device 30 cannot acquire the time lengths T1 and T2 from only the own transmission and reception records.

Therefore, in step S110, the portable device 20 may include information regarding the time lengths T1 and T2 in the payload of the second data transmission signal to transmit the information.

Thus, in step S112, the in-vehicle device can calculate a ranging value which is an estimated value of a distance between the portable device 20 and the in-vehicle device 30 by calculating the propagation time τ and multiplying the propagation time by a speed of an existing signal.

The example of the ranging flow according to the embodiment has been described above. In the process of the example described above, the ranging value can be calculated and control or the like of the moving object based on the ranging value can be realized.

As described above, however, reception sensitivity for the data transmission signal is lower than reception sensitivity for the ranging signal. Therefore, when the data transmission signal cannot be received normally, despite normal completion of the transmission and reception of the ranging signal, a situation where the ranging value cannot be calculated can occur.

The technical idea according to an embodiment of the present invention has been finalized focusing on the foregoing description and is to realize more reliable calculation of a ranging value.

Therefore, the control unit 110 included in the communication device 10 according to the embodiment controls output intensity of a data transmission signal that has a payload based on reception sensitivity for a plurality of ranging signals transmitted to and received from other communication devices 10.

The payload of the data transmission signal according to the embodiment may include information regarding transmission and reception times of the ranging signals.

For example, in the case of the example illustrated in FIG. 2, the control unit 210 included in the portable device 20 may control output intensity of the first and second data transmission signals based on reception sensitivity of a preamble commonly included in the first to third ranging signals.

As described above, the payload of the second data transmission signal includes the information regarding the time lengths T1 and T2.

Hereinafter, output control of the data transmission signal will be described in more detail.

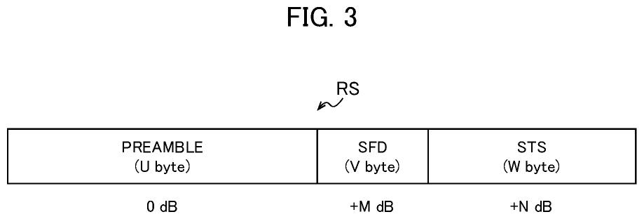

FIG. 3 is a diagram illustrating an example of a data structure of a ranging signal RS according to the embodiment.

As illustrated in FIG. 3, the ranging signal RS according to the embodiment may include, for example, a preamble, a start of frame delimiter (SFD), and a scrambled timestamp sequence (STS).

In FIG. 3, lengths of the preamble, the SFD, and the STS are assumed to be U byte, V byte, and W byte. Values of U to W may be designed appropriately in accordance with content or the like of data to be transmitted.

In FIG. 3, reception sensitivity of each portion when reception sensitivity of the preamble is a reference (0 dB) is exemplified.

In the case of the example illustrated in FIG. 3, when the reception sensitivity of the SFD and the STS is compared with the reception sensitivity of the preamble, the reception sensitivity is respectively higher by M dB and N dB.

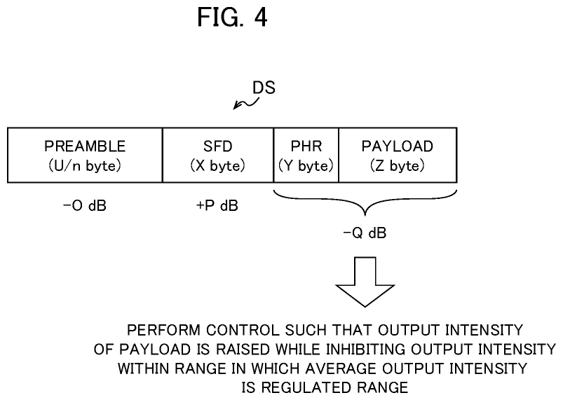

On the other hand, FIG. 4 is a diagram illustrating an example of a data structure of the data transmission signal DS according to the embodiment.

As illustrated in FIG. 4, the data transmission signal DS according to the embodiment may include a preamble, an SFD, a PHR, and a payload.

In FIG. 4, lengths of the preamble, the SFD, the PHR, and the payload are assumed to be U/n byte, X byte, Y byte, and Z byte. Values of U, X to Z, and n may be designed appropriately in accordance with content or the like of data to be transmitted.

In FIG. 4, reception sensitivity of each portion when the reception sensitivity of the preamble of the ranging signal RS is a reference is exemplified.

In the case of the example illustrated in FIG. 4, when the reception sensitivity of the PHR and the payload of the data transmission signal DS is compared with the reception sensitivity of the preamble of the ranging signal RS, the reception sensitivity is lower by Q dB.

In this case, due to the reception sensitivity of the PHR and the payload, a communication distance of the data transmission signal DS is shorter than a communication distance of the ranging signal RS. As a result, even when the ranging signal RS can be received, a situation where the data transmission signal DS is not received and the ranging value cannot be calculated can occur.

To prevent the foregoing situation, the control unit 110 may control the output intensity of the payload so that a communication distance of the data transmission signal DS is equal to a communication distance of the ranging signal RS.

According to the foregoing control, the communication distance of the data transmission signal DS is improved, and thus it is possible to acquire the ranging value more reliably.

On the other hand, when the output intensity of the payload is controlled, an average output intensity of the data transmission signal DS is also raised. Therefore, a situation or the like in which the output intensity exceeds a regulated average can also occur.

To prevent the foregoing situation, the control unit 110 may perform control such that the output intensity of the payload is raised while inhibiting the output intensity within a range in which the average output intensity of the data transmission signal DS is regulated range.

For example, the control unit 110 may set the length of the preamble of the data transmission signal DS to be less than the length of the preamble of the ranging signal RS.

For example, in the case of the example illustrated in FIG. 4, the control unit 110 sets the length of the preamble of the data transmission signal DS to 1/n of the length of the preamble of the ranging signal RS.

According to the foregoing control, even when the output intensity of the PHR and the payload is raised, the average output intensity of the data transmission signal DS falls within the regulated range.

The preamble included in the data transmission signal DS is a repeated arrangement of a regulated pattern. Therefore, even when an amount of data is set to ½(n=1) or ⅓(n=3), it can be said that there is substantially no influence on a series of processes.

The output control of the data transmission signal DS by the control unit 110 according to the embodiment has been described in detail above.

When the output intensity does not exceed the regulated average, the control unit 110 may perform control such that the output intensity of the entire data transmission signal DS is raised.

### Supplements

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

A series of processes by each device described in the present specification may be realized by a program stored in a non-transitory computer-readable storage medium. Each program is read, for example, to a RAM at the time of execution in a computer and is executed by a processor such as a CPU. The storage medium is, for example, a magnetic disk, an optical disc, a magneto-optical disc, a flash memory, or the like. The program may be delivered via, for example, a network without using a storage medium.

What is claimed is:

1. A communication device comprising:
a control unit configured to control ranging with a wireless signal in conformity with a regulated communication standard,
wherein the control unit controls output intensity of a data transmission signal that has a payload based on reception sensitivity for a plurality of ranging signals transmitted to and received from other communication devices.

2. The communication device according to claim 1, wherein the control unit controls the output intensity of the data transmission signal based on reception sensitivity of a preamble commonly included in the plurality of ranging signals.

3. The communication device according to claim 1, wherein the control unit controls the output sensitivity of the data transmission signal that has the payload including at least information regarding transmission and reception times of the ranging signal.

4. The communication device according to claim 3, wherein the control unit raises the output intensity of the payload while restricting a range in which an average output intensity of the data transmission signal is regulated.

5. The communication device according to claim 1, wherein the control unit sets a length of a preamble of a data transmission signal to be shorter than a length of a preamble of the ranging signal.

6. The communication device according to claim 1, wherein the regulated communication standard includes an ultra-wideband wireless communication.

7. A system comprising:
the communication device according to claim 1; and
another communication device configured to receive a data transmission signal from the communication device.

8. A communication method comprising:
controlling ranging with a wireless signal in conformity with a regulated communication standard,
wherein the controlling includes controlling output intensity of a data transmission signal that has a payload based on reception sensitivity for a plurality of ranging signals transmitted to and received from other communication devices.

9. A non-transitory computer-readable storage medium that stores a program causing a computer to realize a control function of controlling ranging with a wireless signal in conformity with a regulated communication standard,
wherein the control function is caused to control output intensity of a data transmission signal that has a payload based on reception sensitivity for a plurality of ranging signals transmitted to and received from other communication devices.
